(19) United States
(12) Patent Application Publication
(10) Pub. No.: US 2019/0321787 A1
(43) Pub. Date: Oct. 24, 2019

(54) Composite Membrane and Method of Separating Gas Using the Same

(71) Applicant: Kyoto University, Kyoto-shi, Kyoto (JP)

(72) Inventors: Easan Sivaniah, Kyoto-shi, Kyoto (JP); Behnam Ghalei, Kyoto-shi, Kyoto (JP); Kento Sakurai, Kyoto-shi, Kyoto (JP); Yosuke Kinoshita, Kyoto-shi, Kyoto (JP); Susumu Kitagawa, Kyoto-shi, Kyoto (JP)

(73) Assignee: Kyoto University, Kyoto-shi, Kyoto (JP)

(21) Appl. No.: 16/347,332

(22) PCT Filed: Nov. 2, 2017
(86) PCT No.: PCT/JP2017/039815

§ 371 Date: May 3, 2019

(30) Foreign Application Priority Data
Nov. 4, 2016 (JP) 2016-216547

(51) Int. Cl. B01D 69/14; B01D 71/72; B01D 71/02; B01D 53/22; B01D 67/00; C08J 5/18

(52) U.S. Cl. CPC B01D 69/148; B01D 71/72; B01D 71/024; C08J 2371/12; B01D 67/0079; C08J 5/18; B01D 53/228

(57) ABSTRACT

Disclosed is a composite membrane comprising a mixed matrix membrane comprising a polymer matrix and fillers dispersed in the polymer matrix. The polymer matrix comprises a polymer having a polar functional group. The H₂ permeability coefficient of the polymer matrix is 20 Barrer or more at 4 bar and 298 K. The filler has a polar functional group that may be capable of forming a hydrogen bond with the polar functional group of the polymer, and has an average diameter of 100 nm or less.

### TECHNICAL FIELD

The present invention relates to a composite membrane and a method of separating a predetermined gas from a mixed gas using the composite membrane.

### BACKGROUND ART

Study has recently been undertaken with respect to Mixed Matrix Membranes (MMMs) for gas separation in which metal organic frameworks (MOFs) are added to polymer matrix (see Non-patent Literatures 1 and 2).

### CITATION LIST

### Non Patent Literature

NPL 1: Rezakazemi, M. et al., Progress in Polymer Science, 39, 817-861 (2014)
NPL 2: Seoane, B. et al., Chemical Society Reviews, 44, 2421-2454 (2015)

### SUMMARY OF INVENTION

### Technical Problem

It is desirable to provide a membrane with high selectivity that can be used to separate predetermined gases such as, for example, H₂, CO₂ and/or O₂ from a mixed gas.

### Solution to Problem

One aspect of the invention provides a composite membrane comprising a mixed matrix membrane. The mixed matrix membrane comprises: polymer matrix comprising a polymer having a polar functional group; and a filler dispersed in the polymer matrix. The H₂ permeability coefficient of the polymer matrix may be 20 Barrer or more at 4 bar and 298 K. The filler may have a polar functional group that is capable of forming a hydrogen bond with the polar functional group of the polymer. The filler may have an average diameter of 100 nm or less. A combination of relatively strong interaction between the polymer matrix and the filler through, for example, hydrogen bonds, and the nano-sized filler, can result in significantly enhanced gas selectivity.

### Advantageous Effects of Invention

A membrane with high selectivity that can be used to separate at least one kind of gas selected from, for example, H₂, CO₂ and O₂ from a mixed gas can be provided. For example, gas separation can be achieved by selectively permeating a predetermined gas in a mixed gas comprising other gases such as N₂ and hydrocarbon through the membrane. The predetermined gas may be at least one kind of gas selected from the group consisting of: hydrocarbon; and other gases containing at least one of a hydrogen atom, a sulphur atom, an oxygen atom or a nitrogen atom. The predetermined gas may be selected from H₂, CO₂ and O₂.

### BRIEF DESCRIPTION OF DRAWINGS

FIG. 1 shows FT-IR spectra of Zr-metal organic framework particles.

FIG. 2 shows PXRD patterns of Zr-metal organic framework particles.

FIG. 3 shows TGA curves of Zr-metal organic framework particles.

FIG. 4 shows SEM images of Zr-metal organic framework particles.

FIG. 5 shows N₂ adsorption isotherms of mixed matrix membranes.

FIG. 6 shows FT-IR spectra of mixed matrix membranes.

FIG. 7 shows PXRD patterns of mixed matrix membranes.

FIG. 8 shows TGA curves of mixed matrix membranes.

FIG. 9 shows N₂ and CO₂ adsorption isotherms of mixed matrix membranes.

FIG. 10 shows SEM images of mixed matrix membranes.

FIG. 11 shows SEM images of mixed matrix membranes.

FIG. 12 shows SEM images of mixed matrix membranes.

FIG. 13 is a table showing a single gas transport data set of mixed matrix membranes.

FIG. 14 shows permeability data of mixed matrix membranes.

FIG. 15 shows permeability data of mixed matrix membranes.

FIG. 16 shows permeability data of mixed matrix membranes.

FIG. 17 shows permeability data of mixed matrix membranes.

FIG. 18 shows permeability data of mixed matrix membranes

FIG. 19 is a SEM image of a mixed matrix membrane.

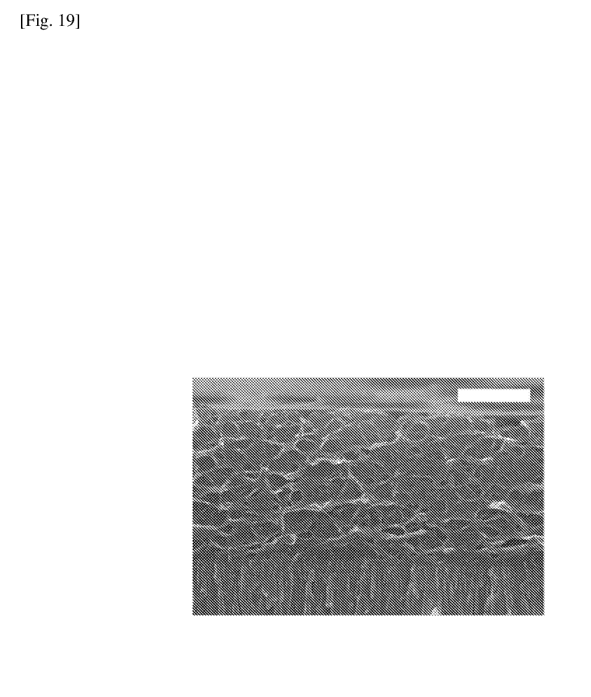

FIG. 20 is a graph showing gas selectivity of mixed matrix membranes.

FIG. 21 shows SEM mixed matrix membranes.

FIG. 22 shows elemental mappings of mixed matrix membranes.

FIG. 23 is a graph showing a relationship between the CO₂ permeability coefficient and time.

### DESCRIPTION OF EMBODIMENTS

Embodiments of the present invention will now be described. The present invention, however, is not limited to the following embodiments.

A composite membrane according to an embodiment comprises a mixed matrix membrane. The mixed matrix membrane comprises a polymer matrix and a filler dispersed in the polymer matrix.

The polymer matrix of the mixed matrix membrane itself has relatively high gas permeability that allows the mixed matrix membrane to have sufficient gas permeability. For example, the H₂ permeability coefficient of the polymer matrix may be 20 Barrer or more, 50 Barrer or more, 200 Barrer or more, or 500 Barrer or more at 4 bar (4×10⁵ Pa) and 298 kelvin (K). The H₂ permeability coefficient of the polymer matrix may be 100,000 Barrer or less. The H₂ permeability coefficient of the polymer matrix can be determined by evaluating a polymer matrix membrane consisting of the polymer matrix only. The H₂ permeability coefficient is measured with a gas permeation test using an H₂ single gas of 4 bar and 298 K as a feed gas.

The polymer that constitutes the polymer matrix may have a polar functional group. The filler may also have a polar functional group. The polar functional groups of the polymer and the filler may be selected so that the polar functional group of the filler can form a hydrogen bond with the polar functional group of the polymer.

The polar functional groups of the polymer and the filler can be selected so that hydrogen bonds could be formed between the polymer matrix and the filler. Examples of pairs of the polar functional groups that can make a hydrogen bond with each other includes a combination of polar functional groups selected from a first group consisting of an amide group, an carboxyl group, a hydroxyl group and an amino group, with a polar functional group selected from a second group consisting of an amide group, a nitrile group, an ether group, a carboxylic acid ester group, a ketone group, a nitro group and a halide group. Typically, the first group can function as a hydrogen donor group, and the second group can function as a hydrogen acceptor group. That is, a polar functional group selected from the first group can form a hydrogen bond with a polar functional group selected from the second group. When the polar functional group of the polymer is selected from the first group, the polar functional group of the filler can be selected from the second group, and vice versa. When the polymer has polar functional groups including both of the first and second group, the filler may have functional groups including either or both of the first and second group, and vice versa. Here, the amide group includes carboxylic amide groups, urethane groups, and imide groups. The ether group means a divalent oxygen atom bonded to saturated or unsaturated hydrocarbon groups that may be substituted. The ketone group means a divalent carbonyl group bonded to saturated or unsaturated hydrocarbon groups that may be substituted.

Examples of the polymer having the polar functional group and allowing the polymer matrix to have relatively high gas permeability coefficient include polymers of intrinsic microporosity. This type of polymer may include a constitutional unit represented by the following formula (I):

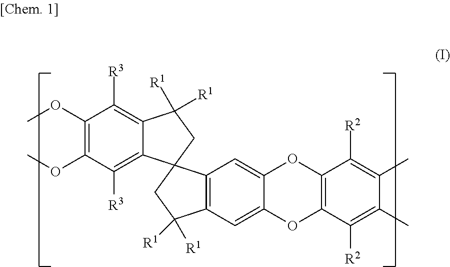

wherein R¹ is a hydrogen atom or a linear or branched C₁-C₅ alkyl group, R² is a hydrogen atom, a linear or branched C₁-C₅ alkyl group, or a cyano group, and R³ is a hydrogen atom, a linear or branched C₁-C₅ alkyl group, or a cyano group. A plurality of R¹, R², and R³ in the same constitutional unit may be the same or different, respectively. A polymer of intrinsic microporosity having the constitutional unit of (I) where R¹s are methyl groups, R²s are cyano groups and R³s are hydrogen atoms, is referred as “PIM-1” hereinafter.

Any other polymers can be used as long as it allows the polymer matrix to have a relatively high gas permeability coefficient. The polymer may be a thermoplastic resin or a thermoplastic elastomer. Examples of such a polymer include polymers comprising a main chain selected from a polyurethane chain, a polyamide chain, and a polyimide chain. The polymer may be a thermoplastic polyurethane elastomer, or a thermoplastic polyamide elastomer comprising a hard segment of a polyamide chain and a soft segment like a polyether chain.

The content of the polymer in the polymer matrix, which can be 100% by mass, may be 90% by mass or more, 95% by mass or more, or 80% by mass or more, with respect to the mass of the polymer matrix.

The filler may be a porous filler. The porous filler may have microporosity with a pore size of less than 2 nm, mesoporosity with a pore size of 2 nm to 50 nm, or macroporosity with a pore size of greater than 50 nm. The pore size can be determined using a N₂ adsorption isotherm.

The porous filler may be comprised of any porous particles, examples of which include metal organic framework (MOF) particles, zeolite particles and silica gel particles. These can be easily functionalized with polar functional groups by conventional methods. The polar functional groups may be present in an external surface of the porous fillers.

An example of the MOF is a zirconium-metal organic framework (Zr-MOF) that comprises zirconium ions or zirconium clusters and organic ligands. The organic ligands function as an organic linker by connecting the plurality of the zirconium ions or zirconium clusters to form a framework. The organic ligands can have the polar functional group, which may be capable of forming a hydrogen bond with the polymer in the polymer matrix. Examples of the organic ligands include an aromatic carboxylic acid with two or more carboxyl groups like terephthalic acid, which may be functionalized with the polar functional group.

The filler may also be a polyhedral oligomeric silsesquioxane particles. The polyhedral oligomeric silsesquioxane (POSS) composing the particles can be represented by the following formula (II):

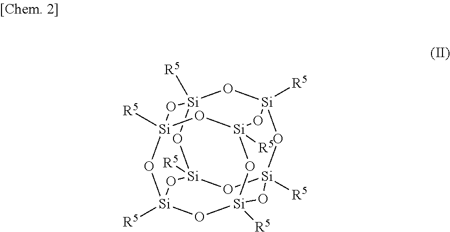

wherein R⁵ represents an alkyl group substituted with a polar functional group or an aryl group substituted with a polar functional group. A plurality of R⁵s in the same molecule may be the same or different. The carbon number of the alkyl group for R⁵ may be 1 to 20 or 1 to 10. The aryl group for R⁵ may be a phenyl group. The polar functional group may be capable of forming a hydrogen bond with the polar functional group of the polymer. Examples of R⁵ with the polar functional group includes an aminoalkyl group, a p-aminophenyl group and a p-nitrophenyl group. R⁵ of the POSS can be functionalized with a polar functional group by conventional methods.

The filler may be nano-sized. Specifically, the average diameter of the filler can be 100 nm or less, 80 nm or less, or 60 nm or less. Here, the diameter of the filler means the maximum width of each particle when the particles are observed with a microscope. The average diameter can be determined by evaluating an appropriate number of the particles, for example, more than 10 particles. The lower limit of the average diameter of the filler, which is not particularly limited, may be 0.5 nm or more.

Particle diameter of the MOF particles can be modulated to be nano-sized by, for example, adding water in a solution in which the MOF particles are synthesized. The solution to synthesize the MOF particles, which could be a slurry, may contain a precursor metal compound, the organic ligand and water. The solution may contain water at a molar ratio of 10 to 100 with respect to the metal atom of the precursor metal compound, which can easily result in appropriately nano-sized MOFs.

The POSS particles are generally nano-sized. The average diameter of the POSS particles may be 10 nm or less, 5 nm or less, 3 nm or less or 2 nm or less, and may be 0.5 nm or more or 1 nm or more.

The filler also may be any other nano-sized particle which is functionalized with the polar functional group. Such nano-sized particles have relatively strong interactions with the polymer matrix, which can contribute to enhanced gas selectivity. Examples of the nano-sized particle include an organic or inorganic nanotube, an organic or inorganic nanosheet, and a nanodiamond.

The content of the filler in the mixed matrix membrane may be 50% by mass or less, 40% by mass or less, 30% by mass or less, or 20% by mass or less, with respect to the total mass of the mixed matrix membrane. The content of the filler in the mixed matrix membrane may be 1% by mass or more, 3% by mass or more, or 5% by mass or more, with respect to the total mass of the mixed matrix membrane. An appropriate content of the filler can contribute to sufficient mechanical properties and enhanced gas selectivity of the mixed matrix membrane.

The thickness of the mixed matrix membrane may be 0.05 micrometers or more, 0.2 micrometers or more, 1 micrometer or more, or 20 micrometers or more. The thickness of the mixed matrix membrane may be 100 micrometers or less. The thickness of the mixed matrix membrane according to some embodiments may be 3.0 micrometers or less, 2.0 micrometer or less, or 1.5 micrometer or less, and may be 0.03 micrometers or more, or 0.2 micrometers or more. A thinner mixed matrix membrane results in a composite membrane with greater gas permeance. Thinner membranes tend to have less durability for long time use, but the filler described above can significantly contribute to improvement of the durability of thin composite membranes.

The composite membrane may further comprise a porous substrate on which the mixed matrix membrane is stacked. The porous substrate can function as a support especially for thin mixed matrix membranes. The porous substrate enables easy preparation of the thin mixed matrix membrane. The porous substrate can be comprised of any porous material that allows gas to pass through with substantially no selectivity. The molecular weight cut-off (MWCO) of the porous substrate may be 1 kDa or more. The MWCO of the porous substrate may be 70 kDa or less. Examples of the porous material include polyvinylidene difluoride (PVDF) and ceramics such as alumina. The thickness of the porous substrate may be 100 micrometers to 200 micrometers.

The mixed matrix membrane can be prepared by typical methods such as solution casting and solvent evaporation technique. A solution to be cast may contain the polymer, the filler and an appropriate solvent.

The composite membrane can be used for separating a predetermined gas from a mixed gas for the purpose of, for example, carbon capture and storage (CCS) or sour gas sweetening. The method of separating the gas may comprise causing the predetermined gas in the mixed gas to pass selectively through the composite membrane. The predetermined gas can be, for example, at least one kind of gas selected from the group consisting of: hydrocarbon; and other gases containing at least one of a hydrogen atom, a sulphur atom, an oxygen atom or a nitrogen atom. Examples of the hydrocarbon include alkanes such as CH₄, and alkenes. Examples of the gases other than the hydrocarbon include H₂, CO, CO₂, N₂, and O₂. The predetermined gas may be at least one of H₂, CO₂ or O₂. The composite membrane can have enhanced selectivity with respect to these gases.

### EXAMPLE

1. Synthesis of PIM-1

PIM-1 was synthesized by the following polycondensation reaction between 5,5′,6,6′-tetrahydroxy-3,3,3′,3′-tetramethyl-1,1′-spirobisindane (TTSBI) and 4-dicyanotetrafluorobenzene (DCTB).

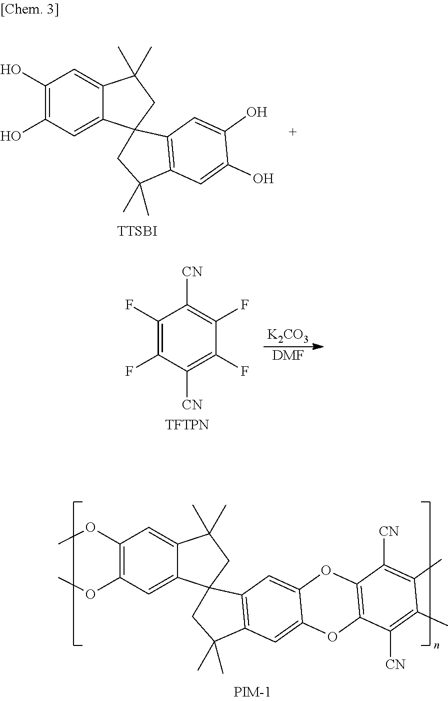

A mixture solution containing 10.2 g of purified TTSBI (Sigma-Aldrich), 6 g of purified DCTB crystal (Wako Pure Chemical), 8.3 g of dried K₂CO₃ (Sigma-Aldrich) and 200 ml of anhydrous dimethylformamide (DMF, Wako Pure Chemical) was stirred under a nitrogen atmosphere at 65 degrees C. for 60 h. The solution was then cooled and poured into 500 mL of pure water. A precipitated solid polymer was then purified by dissolving in chloroform and re-precipitating from methanol, filtered and dried overnight in vacuum oven at 110° C. The molecular weight of the purified polymer was determined by gel permeation chromatography (GPC), giving a number average molecular weight Mn of 110,000 Dalton and a polydispersity (PDI) of 2.1.

2. Porous Filler (Zr-MOF Particles)

2-1. Synthesis of Zr-MOF Particles

Various derivatives of Zr-MOF particles comprising zirconium clusters (Zr₆O₄(OH)₄) and organic ligands were prepared from a mixture of zirconium tetra chloride (ZrCl₄) and terephthalic acid, 2-amino-1,4-dicalboxybenzene, or 2-bromo-1,4-dicalboxybenzene.

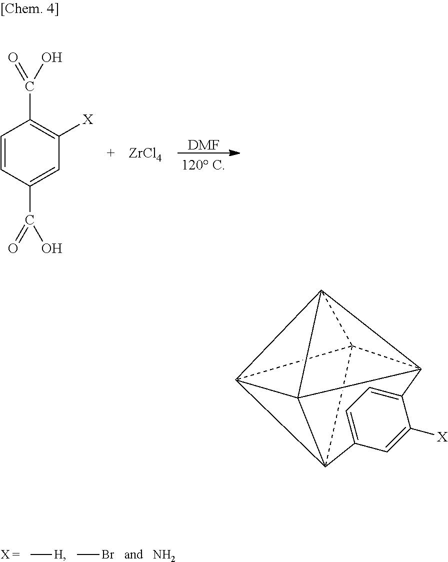

A mixture containing 2.3 mmol of zirconium tetra chloride, 2.3 mmol of the organic ligand and 30 mL of dimethylformamid (DMF) was stirred for 30 minutes, and the resulting slurry was introduced in a 100 mL Teflon (a registered trade mark) lined autoclave.

In order to decrease the size of the resulting crystal to form nano-sized Zr-MOF particles, 113.5 mmol of water was slowly added to the slurry. Then the slurry was stirred for 10 minutes, and heated at 120 degrees C. for 24 hours. The resulting Zr-MOF particles were separated by centrifugation, followed by washing with methanol twice to remove the excess of unreacted ligands. The final Zr-MOF particles were washed with chloroform over 3 days, while replacing the chloroform each day. The obtained Zr-MOF particles were dispersed in fresh chloroform to form a colloid for use in membrane preparation. The yield of Zr-MOF particles was about 45 mol % based on the ideal molar conversion of zirconium. A part of the prepared Zr-MOF particles was dried under vacuum at 150 degrees C. for 12 hours and stored dry for further analysis.

The resulting water modulated Zr-MOF particles obtained with terephthalic acid, 2-amino-1,4-dicarboxybenzen, and 2-bromo-1,4-dicarboxybenzen are referred as UiO-66-H, UiO-66-NH₂, and UiO-66-Br, respectively. Non-modulated Zr-MOF particles referred as UiO-66-ref were also prepared using terephthalic acid in the same manner with the water modulated Zr-MOF particles except that no water was added to the slurry.

2-2. FT-IR Analysis of Zr-MOF Particles

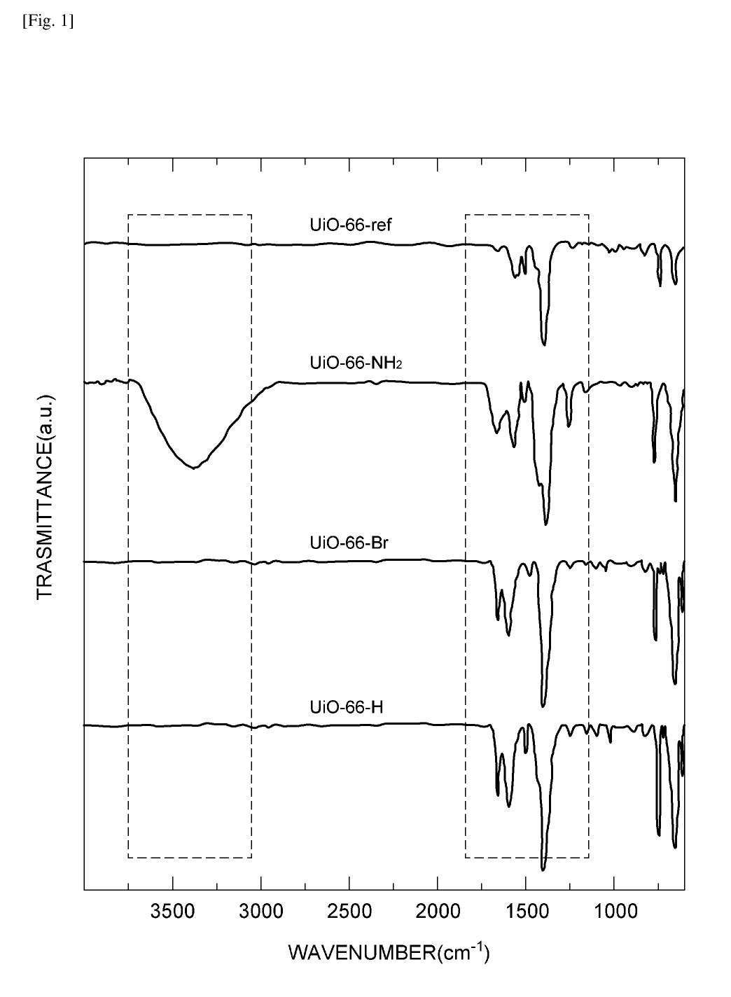

The obtained Zr-MOF particles were investigated by a Fourier Transform Infrared spectrometer (FT-IR, Shimaduzo, IRTracer-100), equipped with an attenuated total reflectance (ATR) cell in the range of 4000 to 500 cm⁻¹. FIG. 1 shows FT-IR spectra of the UiO-66-ref, UiO-66-H, UiO-66-NH₂ and UiO-66-Br. All the Zr-MOF particles showed a peak at 1550-1650 cm⁻¹ corresponding to the symmetric stretching of carboxylate groups (υ(COO)), which is coordinated with metal centres during the deprotonation. The weak peak in the region of 1450-1500 cm⁻¹ is associated with the stretching vibration of C—C in the aromatic compound of organic linker ring. The strong peak centered around 1400 cm⁻¹ was ascribed to symmetric stretching of C—O bonds in the carboxylic acid groups. The FT-IR spectrum of the UiO-66-Br showed features similar to those of the UiO-66-H. Although there is no specific carbonhalogen stretching vibration modes for aromatic halogen structures, the changes in the peak intensities which are sensitive to the bromo-functionality (e.g. at 680 cm⁻¹) were observed in the FT-IR spectrum. Compared with the FT-IR spectrum of UiO-66-H, the stretching vibration adsorption of the amino groups in UiO-66-NH₂ was clearly observed in the high-frequency region at 3000-3500 cm⁻¹. A peak at lower frequencies centered at 1250 cm⁻¹ corresponds to the N—H bending vibration and the characteristic C—N stretching of aromatic amines.

2-3. Powder X-Ray Diffraction (PXRD) Analysis of Zr-MOF Particles.

The crystalline structure of Zr-MOF particles were characterized with a powder X-ray diffraction (PXRD, Rigaku RINT, Japan) with Cu Kα anode operated at 40 mA and 40 kV. The synthesized Zr-MOF particles were crushed with a pestle and mortar. A small amount of sample was then mounted onto a sample holder and flattened using a glass slide. The samples were then scanned over a 20 range of 5-60 degrees.

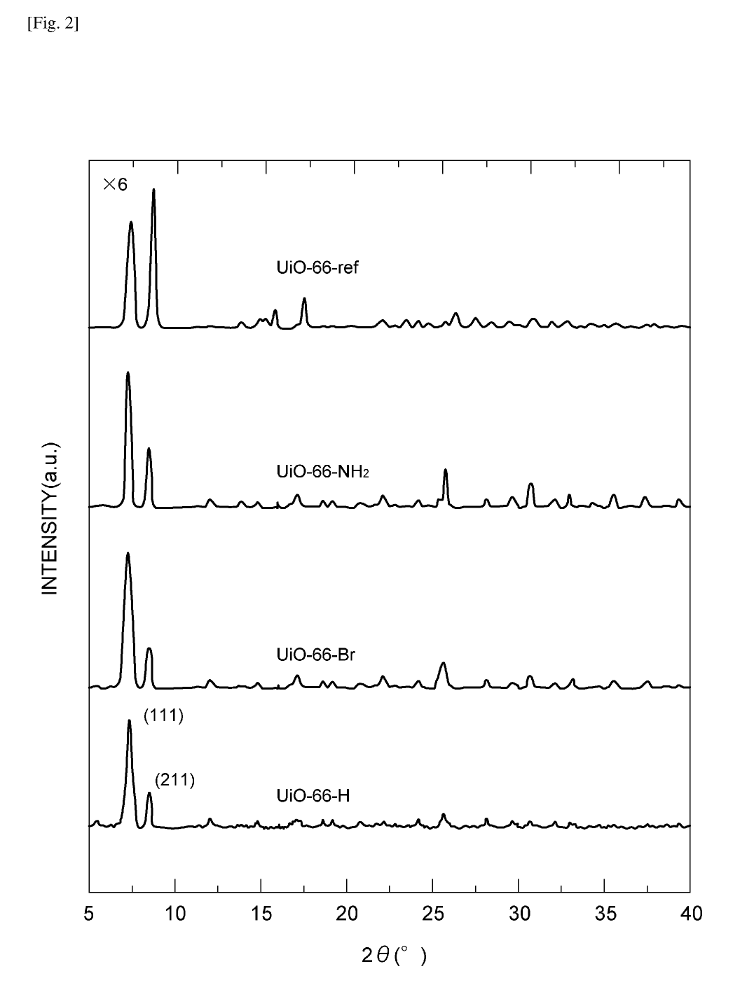

FIG. 2 shows PXRD patterns of UiO-66-ref, UiO-66-H, UiO-66-NH₂ and UiO-66-Br. The PXRD pattern of UiO-66-ref showed two peaks at 7.5 degrees and 8.5 degrees corresponding to [111] and [200] crystal planes respectively, which concur well with the existing literature (see Kang, I. J. et al., Chemistry-A European Journal, 17, 6437-6442 (2011)). The PXRD patterns of the water modulated Zr-MOF particles showed similar features, indicating an isostructural UiO-66 framework topology.

2-3. Thermal Gravimetric Analysis (TGA) of Zr-MOF Particles

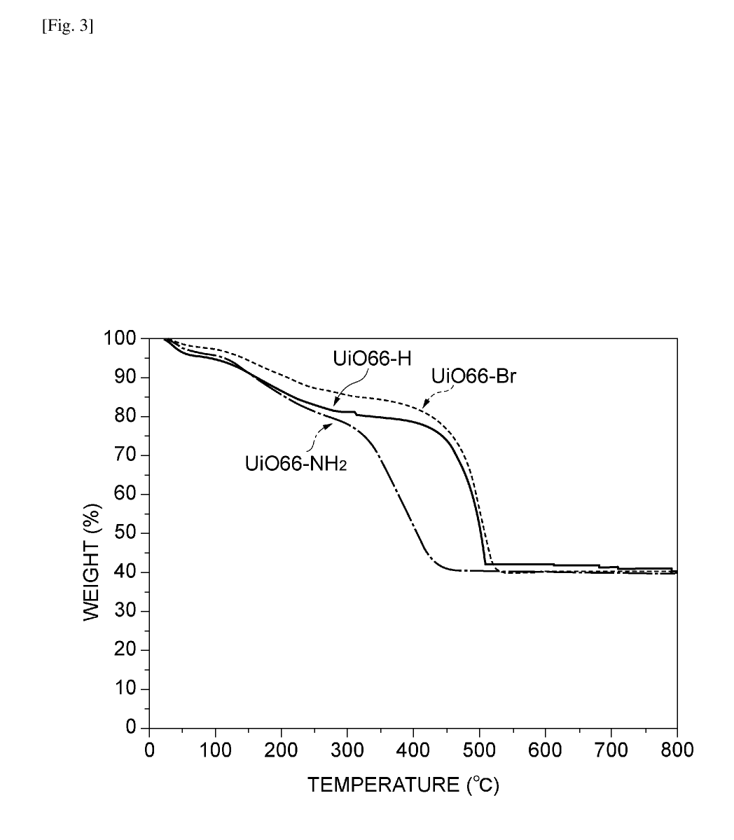

The Zr-MOF particles were evaluated by thermal gravimetric analysis (TGA, Rigaku TG8120, Japan) under flowing nitrogen with 10 K/min ramp rate. FIG. 3 shows TGA curves of UiO-66-H, UiO-66-NH₂ and UiO-66-Br. The Zr-MOF particles exhibited around 5% weight loss at around 75-100 degrees C., corresponds to the departure of the guest molecules (chloroform and/or H₂O) followed by a drop at around 200 degrees C. which is due to the dehydration of the Zr₆O₄(OH)₄ nodes to Zr₆O₆. The final step near 350-500 degrees C. is attributed to decomposition of the organic linkers.

2-4. SEM Analysis of Zr-MOF Particles

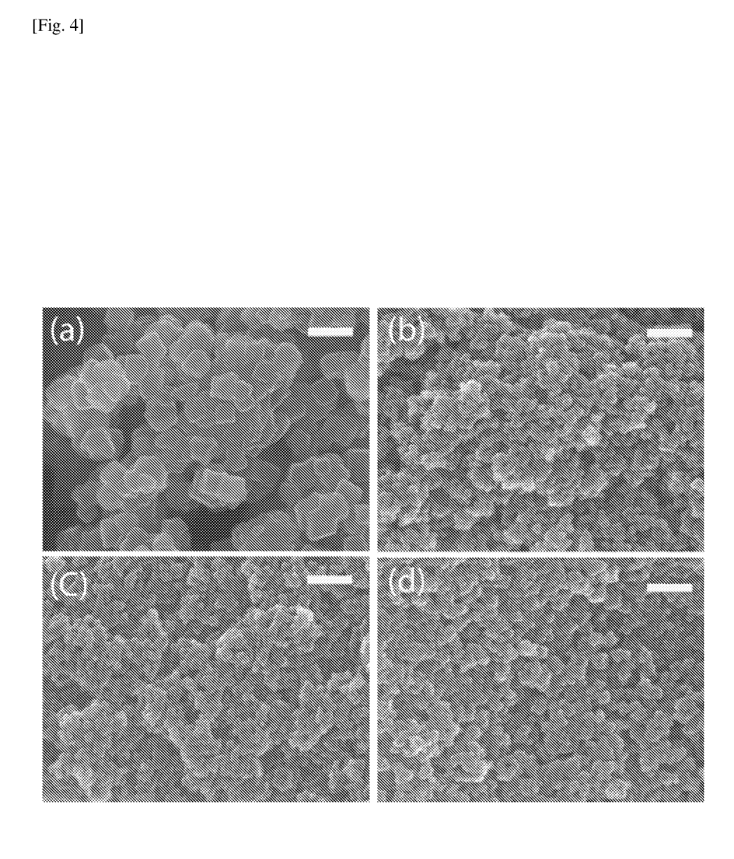

The surface morphology of the synthesized particles was observed with an FESEM (Hitachi S-4800, Japan) instrument. FIG. 4 shows SEM images of UiO-66-ref, UiO-66-H, UiO-66-NH₂ and UiO-66-Br. UiO-66-ref showed agglomerated cubic crystals with particle diameters of around 100-200 nm (see (a) of FIG. 4). UiO-66-H ((b) of FIG. 4), UiO-66-Br ((c) of FIG. 4) and UiO-66-10 NH₂ ((d) of FIG. 4) particles, which were prepared utilizing water modulation, had particle diameters of around 20-30 nm, apparently less than 100 nm.

2-5. N₂ Adsorption Isotherms and BET Surface Area of Zr-MOFs

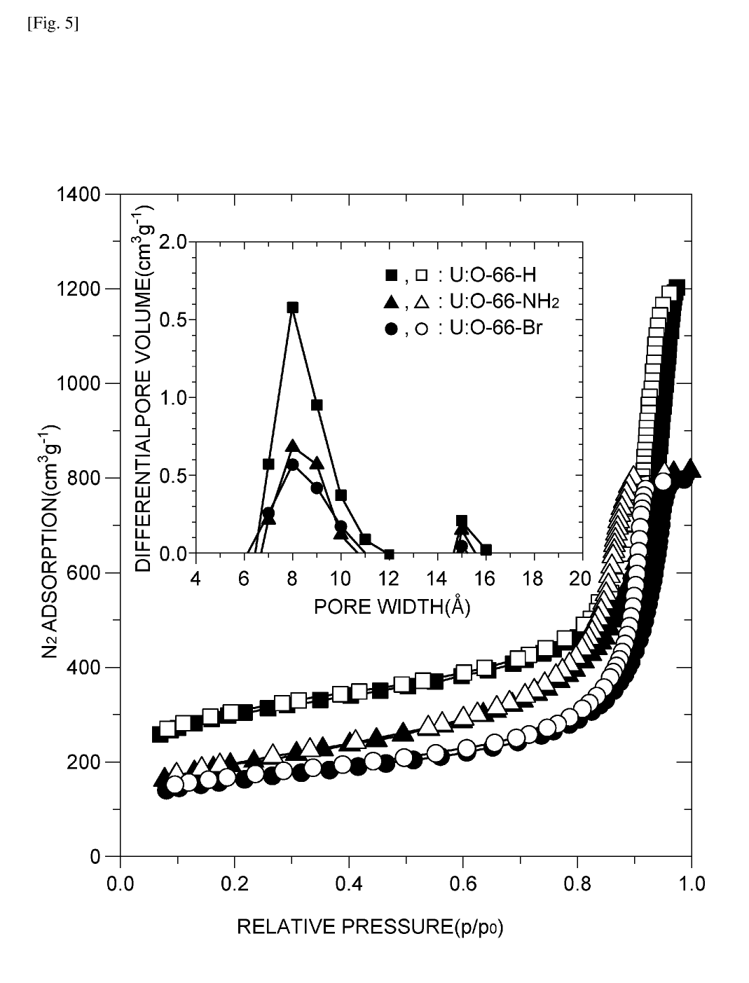

Nitrogen adsorption isotherms of Zr-MOF particles were prepared using BELSORP-Max instrument (BEL Inc. Japan) at 77 K to investigate the specific surface area and the pore size (pore width) of the Zr-MOF particles. FIG. 5 shows N₂ adsorption isotherms at 77K of UiO-66-H, UiO-66-NH₂ and UiO-66-Br. The inset in FIG. 5 shows pore-size distribution derived from the isotherms. All of the Zr-MOF particles indicated the presence of microporosity with the pore size being less than 2 nm owing to the framework structure, and mesoporosity with the pore size being 2-50 nm arose from interstitial voids between aggregated nanoparticles.

The specific surface area (SBET) was calculated from the obtained N₂ adsorption isotherms based on the Brunauer&#8211; Emmett&#8211; Teller (BET) model. Table 1 shows the surface area of Zr-MOF particles. The BET surface area of the UiO-66-H is 1115.4 m²/g, which is a little lower than that of the larger UiO-66-ref particles (1320 m²/g). This is possibly due to the different degree of crystallinity under modulation conditions with water. In the functionalized UiO-66-NH₂ and UiO-66-Br, the BET surface areas decreased to 708.6 and 585.4 m²/g, respectively. This is attributed to protrusions of the bulky —NH₂ or —Br groups into the empty space of the micropores.

TABLE 1

| | BET surface area | Langmuir surface | Total pore |
|---|---|---|---|
| Zr-MOFs | (m²/g) | area (m²/g) | volume (cm³/g) |
| UiO-66-ref | 1320.1 | 1478.2 | 0.43 |
| UiO-66-H | 1115.4 | 1187.9 | 0.41 |
| UiO-66-NH₂ | 708.6 | 765.3 | 0.29 |
| UiO-66-Br | 585.4 | 639.4 | 0.25 |

3. Mixed Matrix Membrane (MMM)

3-1. Preparation of Mixed Matrix Membrane

The colloidal solution of UiO-66-H, UiO-66-Br or UiO-66-NH₂ in chloroform was sonicated to prevent particulate aggregation. The dried PIM-1 was dissolved in chloroform at concentration of 8% by mass. The PIM-1 solution was then poured into the colloidal solution, while being filtered through a PTFE syringe filter having a pore size of a 0.45 micrometers. The resulting PIM-1/Zr-MOF solutions were stirred overnight. After sonication to remove the air bubbles, the PIM-1/Zr-MOF solutions were cast onto a clean glass substrate. The solutions on the glass substrate were covered and placed in a glove bag, and then allowed to form a mixed matrix membrane at ambient temperature by solvent evaporation over two days. The resulting membranes were removed from the glass substrate and dried at 110 degrees C. under vacuum prior to gas permeation and structure characterization.

In this manner various MMMs with contents of the Zr-MOF particles at 5% by mass, 10% by mass, 20% by mass, 30% by mass, or 40% by mass were prepared. An unmodified PIM-1 membrane was also prepared in the same manner except for casting a PIM-1 solution with no Zr-MOF particles onto a clean glass substrate.

The thicknesses of the obtained MMMs were within the range of 80-100 micrometers, as measured by a micrometer (Mitutoyo, Model 5406, Japan). The porous filler content of up to 40% by mass was possible for UiO-66-H, UiO-66-NH₂ and UiO-66-Br before the MMM became too fragile to be tested, while the porous filler contents of up to 20% by mass was possible for UiO-66-ref. It was observed that nano-sized porous fillers of UiO-66-H, UiO-66-NH₂ and UiO-66-Br gave the MMMs with higher optical transparency than UiO-66-Ref. The MMM comprising PIM-1 and UiO-66-NH₂ includes a combination of polar functional groups that can form a hydrogen bond.

3-2. FT-IR Analysis of MMMs

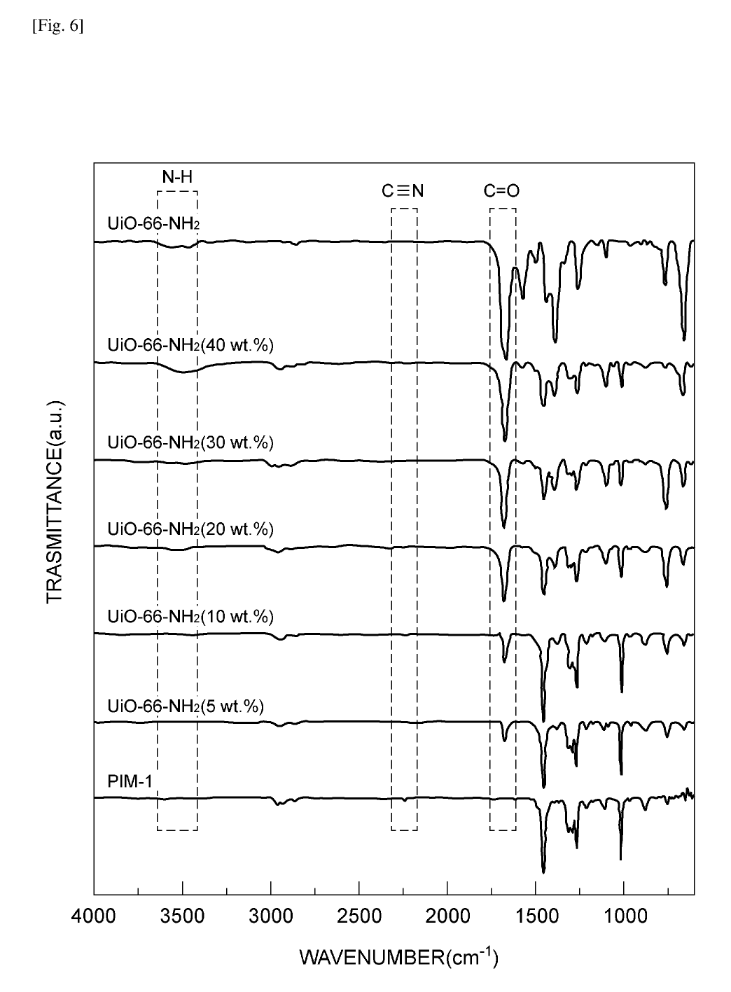

The obtained MMMs were investigated by a Fourier Transform Infrared spectrometer (FT-IR, Shimaduzo, IRTracer-100), equipped with an attenuated total reflectance (ATR) cell in the range of 4000 to 500 cm⁻¹. FIG. 6 shows FT-IR spectra of the MMMs comprising UiO-66-NH₂ and the unmodified PIM-1 membrane. The spectrum of the unmodified PIM-1 membrane matches existing literature (Hao, L., et al., Journal of Materials Chemistry A, 3, 17273-17281 (2015)) well. In the spectra of the MMMs, the appearance of the broad N—H band at 3200-3600 cm⁻¹ as well as the C═O band at 1650-1710 cm⁻¹ indicate the presence of UiO-66-NH₂ particles inside the PIM-1 matrix. There was a decrease in absorption between 1300 and 1100 cm⁻¹ in these MMMs, which could be due to hydrogen bonds between the aromatic ether groups of the PIM-1 and the amino group grafted to the external surface of the Zr-MOF.

3-3. PXRD Analysis of MMMs

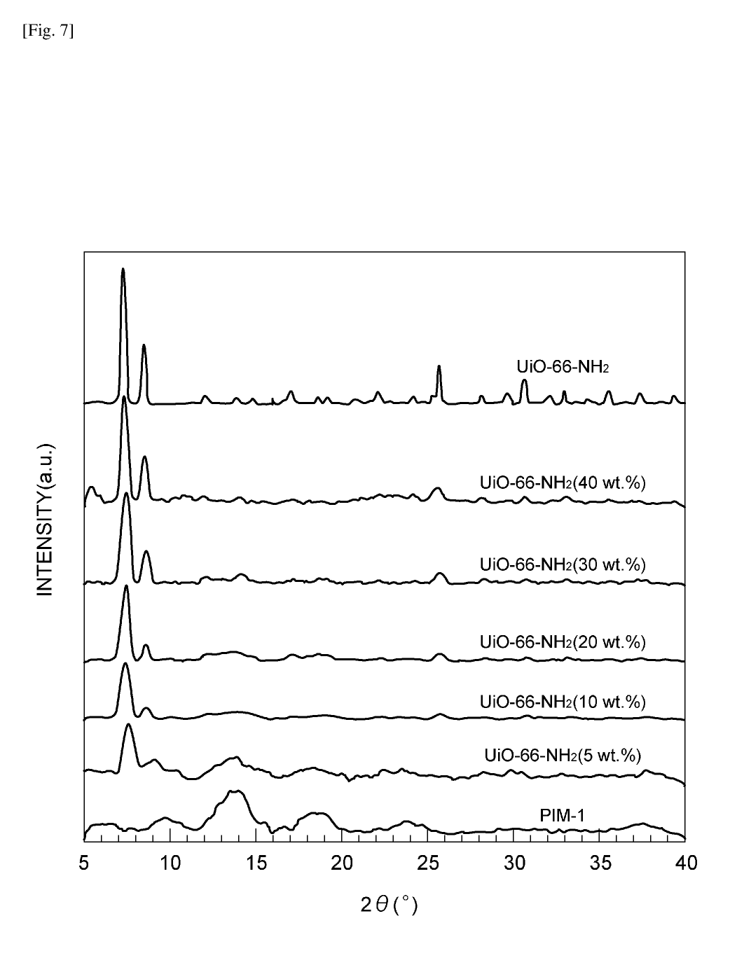

FIG. 7 shows PXRD patterns of the MMM of UiO-66-NH₂ and the unmodified PIM-1 membrane. The PXED patterns proved the integrity of the Zr-MOF crystals at any contents of the Zr-MOF particles in the PIM-1 matrix.

3-4. Thermal Gravimetric Analysis (TGA) of MMMs

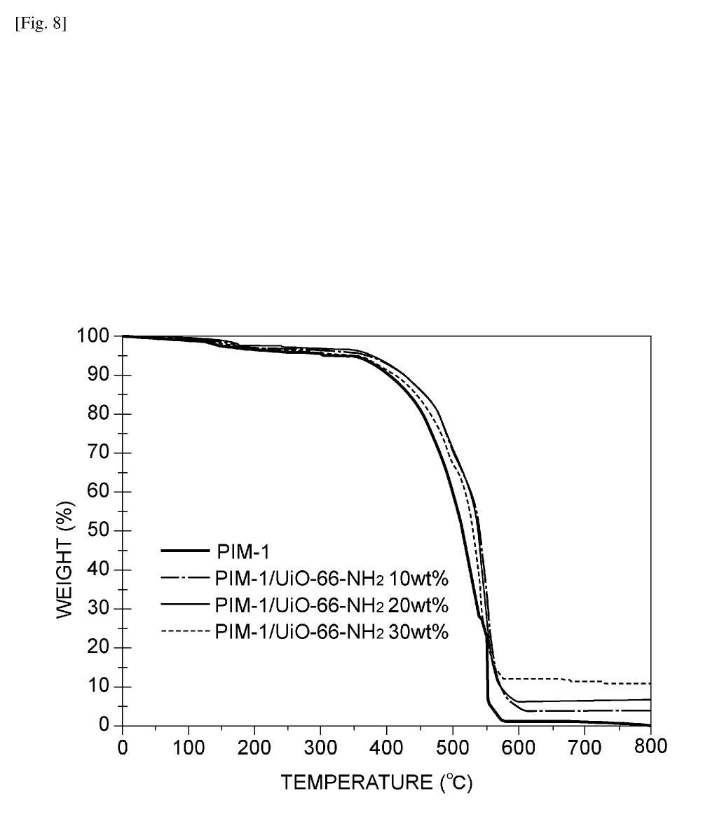

The MMMs were evaluated by thermal gravimetric analysis (TGA, Rigaku TG8120, Japan) under flowing nitrogen with 10 K/min ramp rate. FIG. 8 shows TGA curves of the MMM of UiO-66-NH₂ and the unmodified PIM-1 membrane. Thermal degradation of PIM-1 started at around 390 degrees C. Above this temperature, continuous weight loss was observed. The thermal stabilities are improved upon the introduction of UiO-66-NH₂ into the PIM-1 matrix and the slope of weight reduction decreases as the contents of UiO-66-NH₂ in the MMM increase.

3-5. Gas Adsorption Isotherms of MMMs

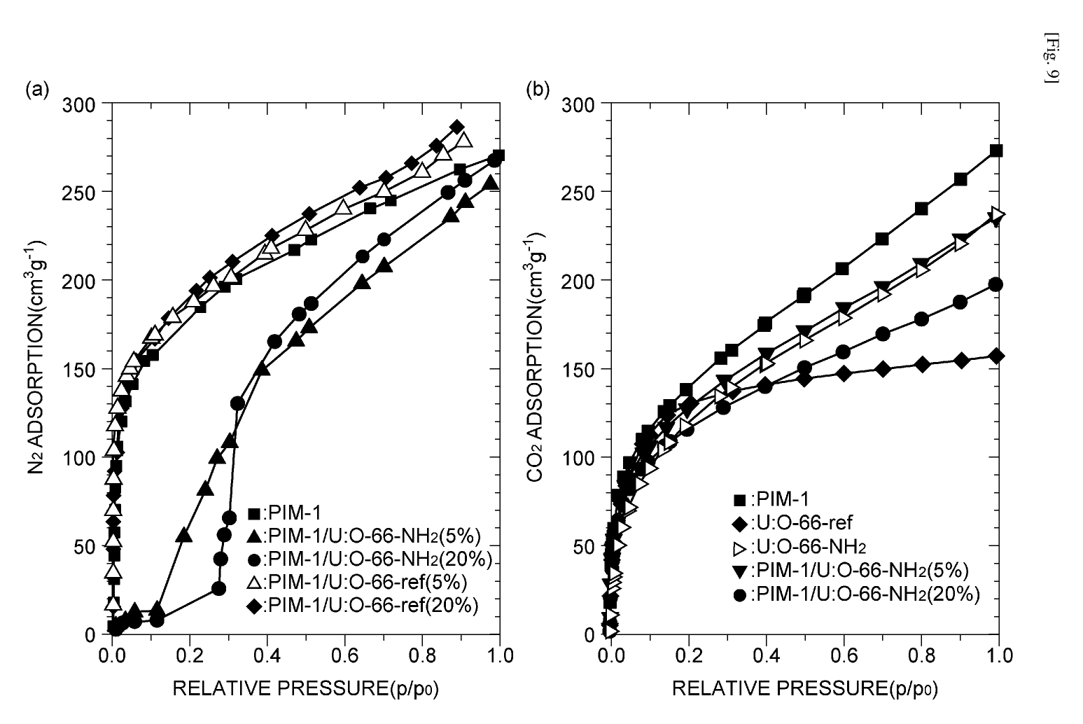

Gas adsorption isotherms of the membranes were prepared using BELSORP-Max instrument (BEL Inc. Japan) at 77 K to investigate the free volume structure in the membranes. The samples were degassed at 100 degrees C. for 24 h under vacuum before testing. FIG. 9 shows N₂ and CO₂ adsorption isotherms at 195 K of the MMMs of UiO-66-ref or UiO-66-NH₂ and the unmodified PIM-1 membrane. The MMM of UiO-66-ref showed behavior similar to that of the unmodified PIM-1 membrane with high nitrogen adsorption at low pressures. The N₂ adsorption of the MMM of UiO-66-NH₂ showed a commonly observed gate-opening behavior at 77 K, indicating diffusion-restricted adsorption and densification at interfaces that arise from the presence of interactions between the PIM-1 matrix and Zr-MOF particles, which was not present for the MMM of UiO-66-ref. The MMM of UiO-66-NH₂ had a higher adsorption capacity than the MMM of UiO-66-ref. Further addition of the UiO-66-NH₂ to the PIM-1 matrix decreased the gas uptake, because of constrained polymer chain packing at the MOF/polymer interface region.

3-6. SEM Analysis of MMMs

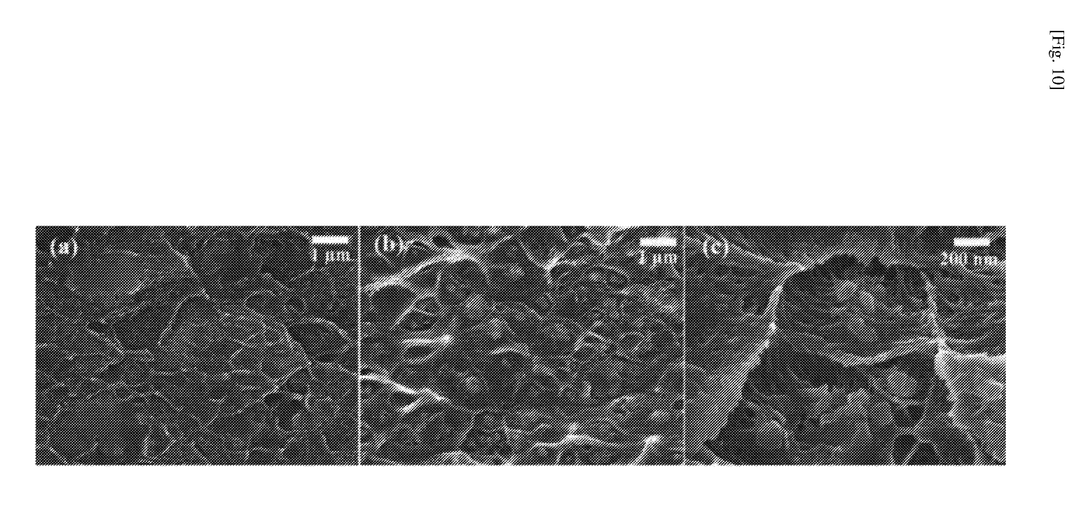

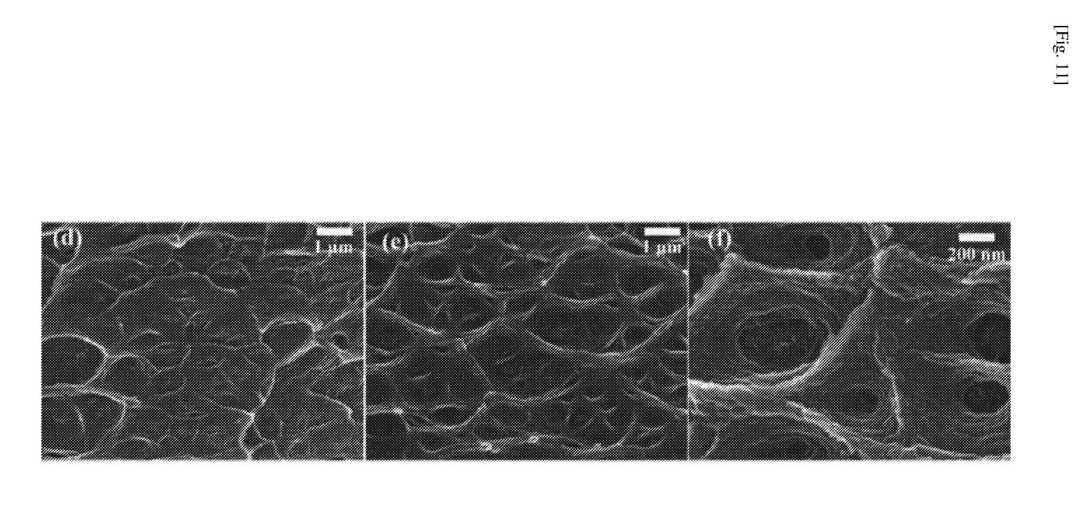

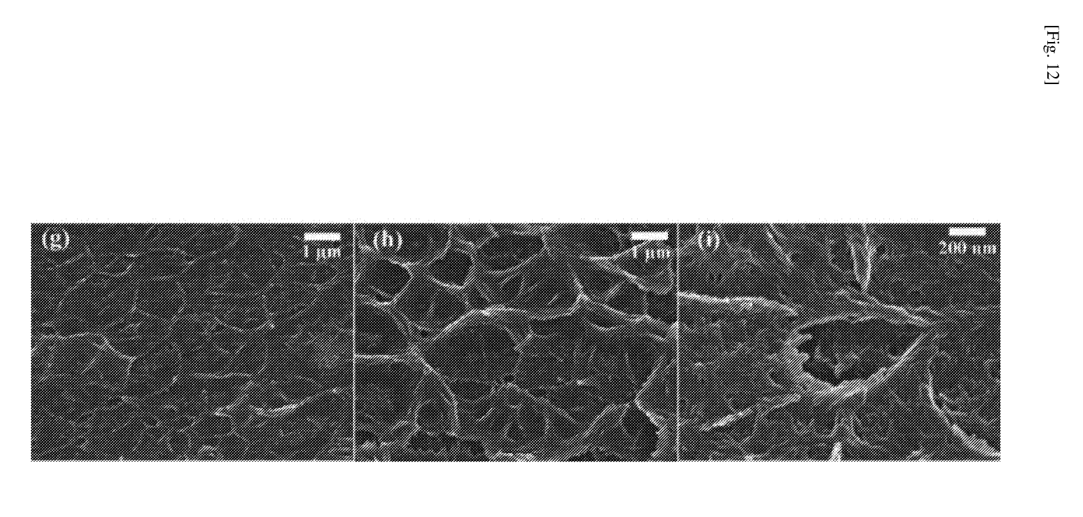

The cross-section morphology of the MMMs was observed by an FESEM (Hitachi S-4800, Japan) instrument. Cross-sections of the membranes were obtained by fracturing in liquid nitrogen, and were sputtered with osmium to prevent charging. FIGS. 10, 11 and 12 show SEM images of the MMMs. FIG. 10 shows the MMM comprising 5% by mass ((a)) or 20% by mass ((b) and (c)) of UiO-66-ref. FIG. 11 shows the MMM comprising 5% by mass ((d)) or 20% by mass ((e) and (f)) of UiO-66-H. FIG. 12 shows the MMM comprising 5% by mass ((g)) or 20% by mass ((h) and (i)) of UiO-66-NH₂. No large agglomerates were seen in the MMMs comprising UiO-66-H or UiO-66-NH₂. The particle/polymer interfacial adhesion was also improved markedly by introducing —NH₂ groups.

3-7. Gas Permeation Test (Single Gas)

Single gas permeability of the membranes with respect to H₂, N₂, O₂, CH₄ and CO₂ was evaluated using the constant pressure-variable volume method at room temperature (25° C.). The membrane was held in a Millipore commercial filter holder with steel meshed supports, and placed in a permeate chamber. The gas permeate pressure was recorded by pressure transmitters (Keller PAA 33X).

The pressure in the adsorption chamber was adjusted until the inside pressure is equi-librated within the target pressure interval (less than 10 Pa difference). The equilibrium time varied between few minutes to several hours depending on the type of gas and pressure at each point. Each experiment was performed over a period of approximately one day.

The gas permeability coefficient (P) was calculated based on the following equation:

$$\begin{matrix}[ Math . 1 ] & \\ P = \frac{Vl}{A} \frac{{T}_{0}}{{p}_{f} {p}_{0} T} ( \frac{dp}{dt} ) & ( 1 )\end{matrix}$$

where P is the permeability coefficient of the gas through the membrane in Barrer (1 Barrer=10⁻¹⁰ cm³ (STP) cm cm⁻² s⁻¹ cmHg⁻¹), V is the permeate volume (cm³), 1 is the thickness of membrane (cm), A is the effective area of the membrane (cm²), p_{f} is the feed pressure (cm Hg), p₀ is the pressure at standard state (76 cm Hg), T is the absolute operating temperature (K), T₀ is the temperature at standard state (273.15 K), and (dp/dt) is the slope of pressure increase in the permeate volume at pseudosteady state (cm Hg/s).

The diffusion coefficient (D) for a specific gas can be derived from the thickness of the membrane and the time lag (θ):

$$\begin{matrix}[ Math . 2 ] & \\ D = \frac{{l}^{2}}{6 θ} & ( 2 )\end{matrix}$$

Then the solubility (S) can be derived from:

$$\begin{matrix}[ Math . 3 ] & \\ S = \frac{P}{D} & ( 3 )\end{matrix}$$

The ideal selectivity of gas pairs, A and B, is defined as:

$$\begin{matrix}[ Math . 4 ] & \\ {α}_{A \text{/} B} = \frac{{P}_{A}}{{P}_{B}} = [ \frac{{D}_{A}}{{D}_{B}} ] [ \frac{{S}_{A}}{{S}_{B}} ] & ( 4 )\end{matrix}$$

where D_{A}/D_{B} is the diffusivity selectivity and S_{A}/S_{B} is the solubility selectivity. The feed side pressure of the gases ranged from 2 to 8 bar. Permeability coefficients were calculated three times for each membrane. The error for the absolute values of the permeability coefficients could be estimated to about ±7%, due to uncertainties in deter-mination of the gas flux and membrane thickness. However, the reproducibility was better than ±5%.

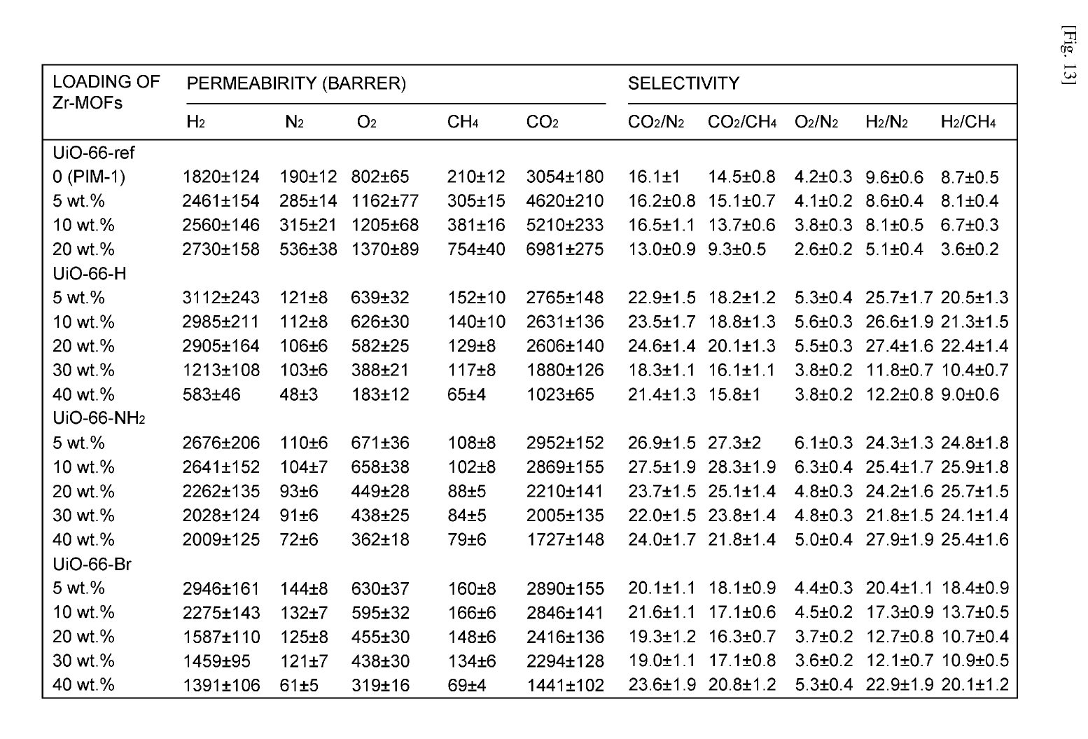

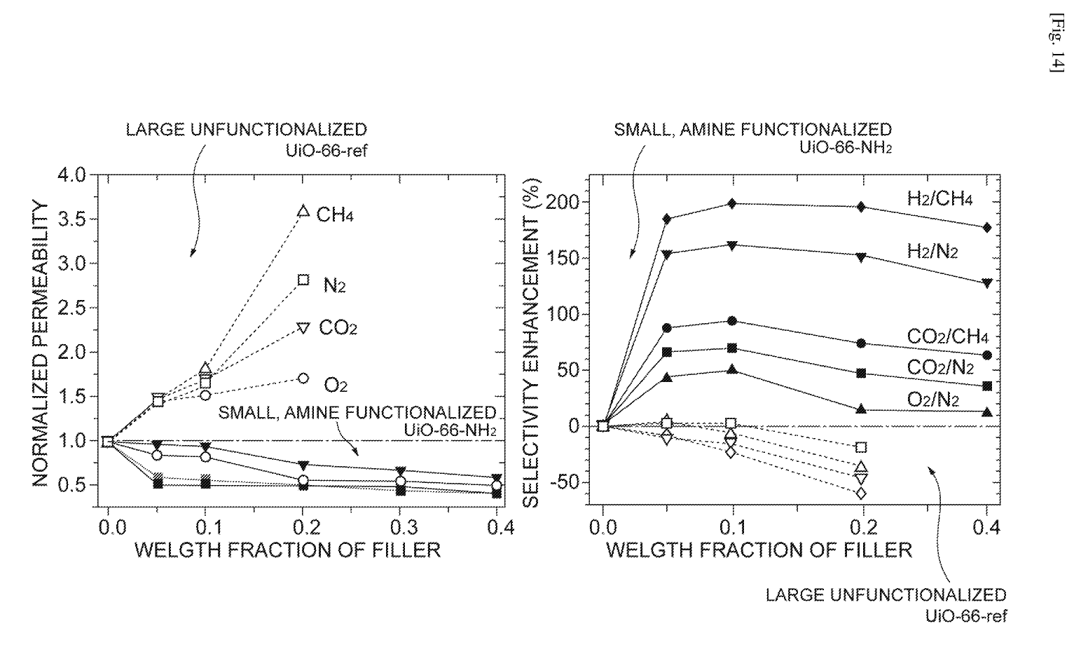

FIG. 13 presents the obtained single gas transport data set at 298 K and 4 bar of the membranes. FIG. 14 shows permeability data for UiO-66-NH₂ and UiO-66-ref. (a) in FIG. 14 is a graph showing relationships between normalized gas permeability coefficient and the content of the Zr-MOF particles. (b) in FIG. 4 is a graph showing relationships between selectivity enhancement and the content of the Zr-MOF particles. The gas permeability coefficient of the unmodified PIM-1 membrane follows the sequence of P (CO₂)>P (H₂)>P (O₂)>P (CH₄)>P (N₂). As the content of the UiO-66-ref increases up to 10% by mass, the permeability coefficient of all gases increased dramatically while the selectivity remained similar to that of the unmodified PIM-1 membrane. At a higher content like 20% by mass, the permeability coefficient increased to around two times that of the unmodified PIM-1 membrane. This higher permeability coefficient and lower selectivity is not unusual and can be attributed to the non-selective diffusion at a defective interface between the Zr-MOF particles and the polymer matrix, as observed in the SEM image showing “sieve-in-a-cage” morphology. In contrast to the UiO-66-ref, the permeability coefficient of the MMMs comprising the UiO-66-H, UiO-66-NH₂ or UiO-66-Br particles decreased at higher contents, while the selectivity of the gases remains at a higher plateau. This trend of an enhanced plateau selectivity was greatly improved for the MMM comprising the UiO-66-NH₂.

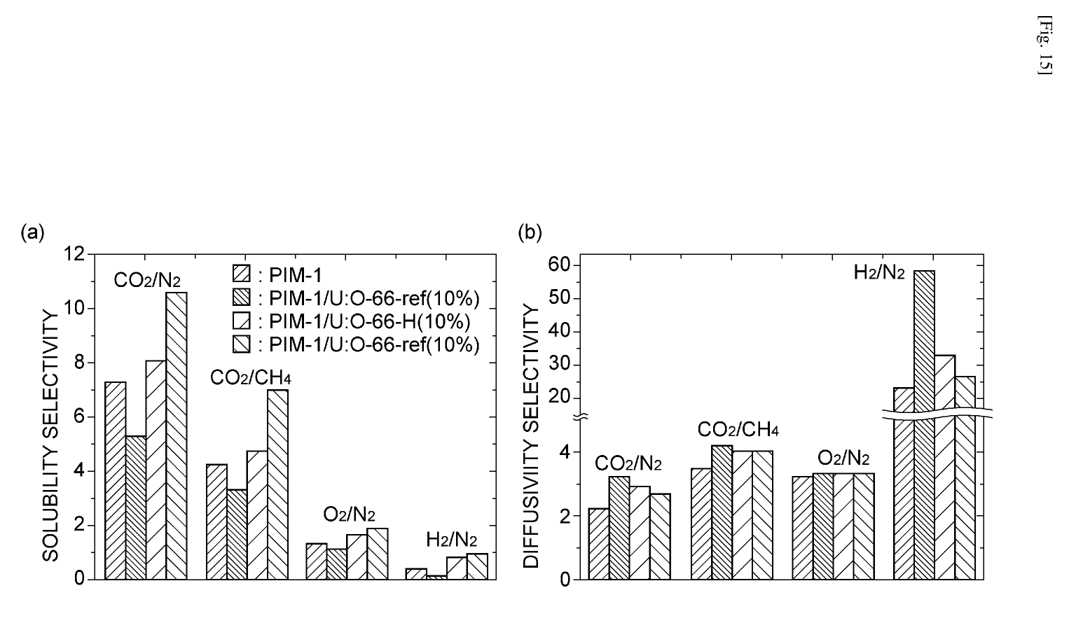

The gas electivity of diffusion or solubility in the membranes was calculated from the permeation data. FIG. 15 shows the solubility selectivity and diffusion selectivity of gases in the membranes. It was confirmed that the major contribution to the increase in gas selectivity comes from increase of the solubility selectivity with both introduction of amino groups and size-modulation. The diffusion selectivity of most gas pairs are unchanged by either factor. This trend suggests a greater participation of the polymer matrix, or a minimization of the defect spaces in the vicinity of the Zr-MOF particles through the enhanced interface interaction between the porous filler and the polymer matrix.

Permeation and selectivity properties in pressure ranges of 2 bar to 32 bar and at operating temperature ranges of 25 to 55 degrees C. were also evaluated. These conditions include high pressure and low temperature that should be required for practical operations for carbon capture and storage (CCS), and sour gas sweetening.

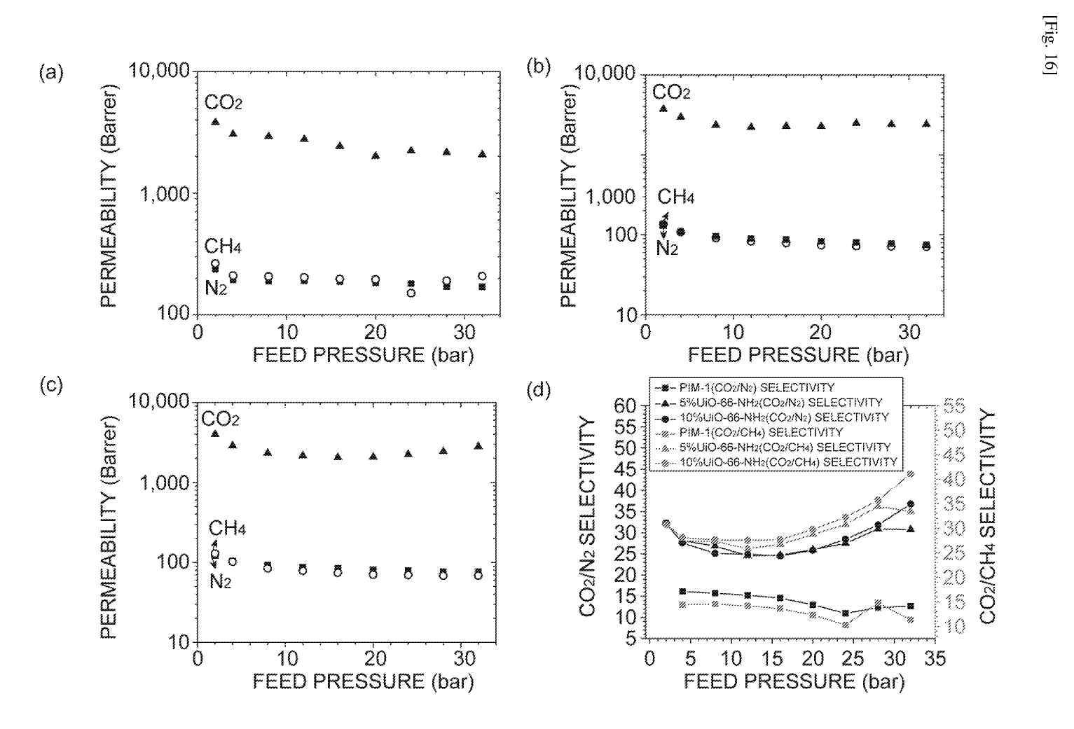

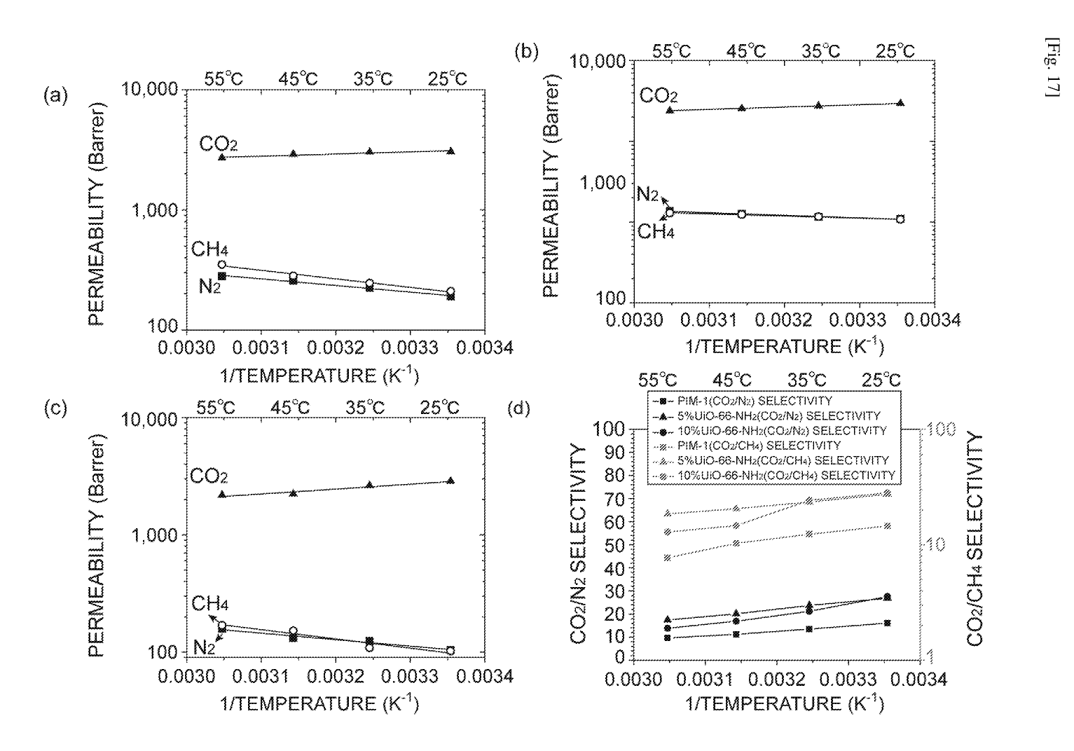

FIG. 16 shows relationships between permeability coefficient or gas selectivity and feed pressure. FIG. 17 shows relationships between permeability coefficient or gas selectivity and temperature. It was confirmed that the MMMs had a consistent permeation and selectivity performance in a broad range of feed pressure and temperature.

3-8. Gas Permeation Test (Mixed Gas)

The mixed gas permeation was measured using the constant pressure-variable volume method. The membrane was exposed to certified CO₂/N₂, or CO₂/CH₄ mixed gas (50/50 vol. %, Kyoto Teisan Co., Japan) with feed pressure up to 16 bar at room temperature (25 degrees C.). The feed flow rate was controlled by a metering valve and measured by a flow meter (Shimadzu Co.). The permeability coefficient and com-positions of permeate gas mixtures were measured by an in-line gas chromatograph (Shimadzu Co., model 2014) equipped with a thermal conductivity detector (TCD) in presence of Helium as a carrier gas.

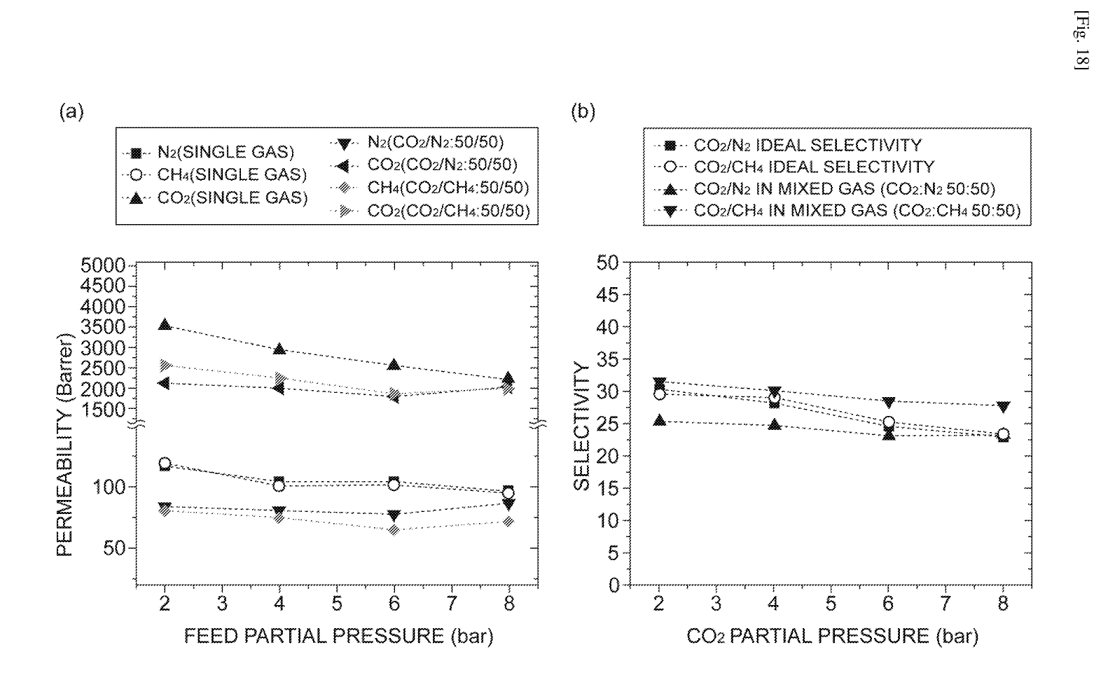

FIG. 18 shows relationships between single and mixed gas permeability coefficient or selectivity and feed gas partial pressure for the MMM of 10% by mass of UiO-66-NH₂. (b) of FIG. 18 shows relationships between selectivity of CO₂/N₂ or CO₂/CH₄ and CO₂ partial pressure. The composite membrane showed performance almost similar to that of single gas permeation tests with slightly lower permeability coefficient. The mixed-gas selectivity was also similar to the ideal selectivity at increased pressure, at higher pressures.

3-9. Thin MMM

One-micron-thick membranes were prepared on a ceramic support in the same manner as described above. Table 2 shows gas permeation properties at 1 bar and 25 degrees C. of the obtained thick membranes. The thin unmodified PIM-1 membrane exhibited CO₂/N₂ selectivity of about 9, which is much less than that of thick membrane. However, it was found that the addition of the amine-functionalized and nano-sized UiO-66-NH₂ allows the one-micron-thick MMM to retain high gas selectivity.

TABLE 2

| | Permeance (GPU) | | Selectivity |
|---|---|---|---|
| | N₂ | CO₂ | CO₂/N₂ |
| PIM-1 | 390 | 3600 | 9.2 |
| UiO-66-NH₂ | 72 | 1740 | 24.1 |
| (5 wt. %) | | | |

3-10. MMMs with Other Polymers

A difunctional poly(ethylene oxide)-poly(propylene oxide) block copolymer ter-minating in primary hydroxyl groups (“Pluronic L35”, by BASF) was reacted with an excess isophorone diisocyante (IPDI) (Pluronic L35:IPDI is 1:3 molar ratio) in the presence of dibutyltin dilaurate (DBTDL) under nitrogen atmosphere at 75 degrees C. to obtain a macro diisocyanate pre-polymer.

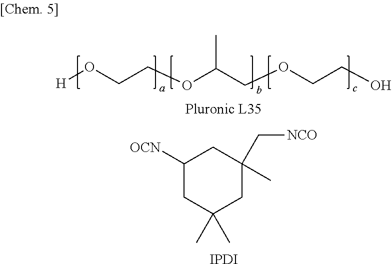

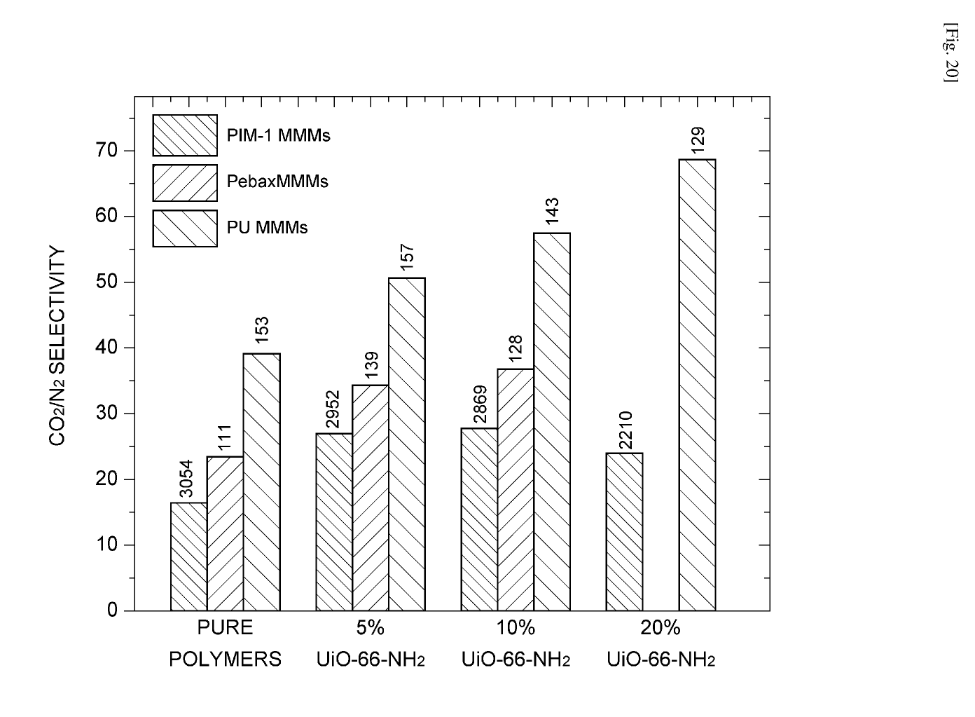

After 2 h, 1,8-octanediamine was added to the reaction mixture as a chain extender with molar ratio of Pluronic L35:IPDI:1,8-octadiamine being 1:3:2 to obtain a polyurethane. A thermoplastic polyamide elastomer (“Pebax 2533” (product name), by Arkema Co.) comprising a polyether block was also prepared. MMMs comprising UiO-66-NH₂ were prepared in the same manner with the MMMs of the PIM-1, except that the PIM-1 was replaced with these other polymers. Unmodified polyurethane membrane and thermoplastic polyamide elastomer membrane were also prepared. The unmodified polyurethane membrane had an H₂ permeability coefficient of 35 Barrer at 4 bar and 298 K. The unmodified thermoplastic polyamide membrane had an H₂ permeability coefficient of 22 Barrer at 4 bar and 298 K. FIG. 20 shows CO₂/N₂ selectivity of the obtained membranes. It was confirmed that the MMMs comprising a polyurethane (PU) or a polyamide (Pebax) exhibited enhanced gas selectivity due to the introduction of amino groups and size-modulation.

3-10. MMMs Comprising POSS Particles

Phenyl-POSS particles comprising a POSS represented by the formula (II) where R⁵s were phenyl groups were prepared. The phenyl groups of the POSS were nitrated with fuming HNO₃ to obtain NO₂-POSS particles, and then the introduced nitro groups were reduced with Pd/C catalyst to give NH₂-POSS particles comprising a POSS where R⁵s were p-amino-phenyl groups as follows:

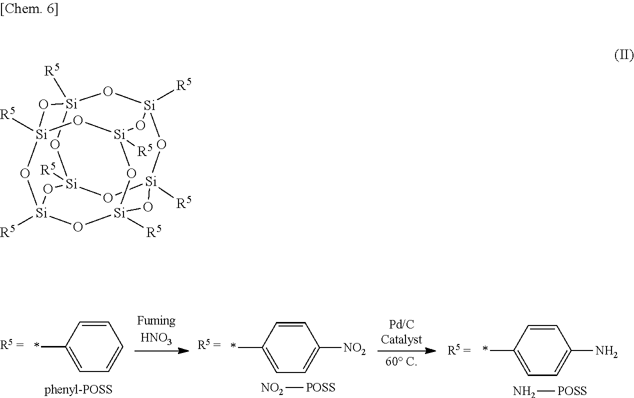

FT-IR and ¹H NMR analysis confirmed that nitro groups were introduced on the phenyl groups of the phenyl-POSS particles, and then converted into amino groups.

Fabrication of Membranes 1

The phenyl-POSS particles and the NH₂-POSS particles were respectively added to chloroform to obtain a POSS dispersion liquids. The dried PIM-1 was dissolved in chloroform at concentration of 8% by mass. The PIM-1 solution was then poured into the dispersion liquid, while being filtered through a PTFE syringe filter having a pore size of a 0.45 micrometers. The resulting PIM-1/POSS solutions were stirred overnight. After sonication to remove the air bubbles, the PIM-1/POSS solutions were cast onto a clean glass substrate. The solutions on the glass substrate were covered and placed in a glove bag, and then allowed to form a transparent MMM at ambient temperature by solvent evaporation over two days. The resulting membranes were removed from the glass substrate and dried at 110 degrees C. under vacuum.

In this manner various MMMs with contents of the NH₂-POSS particles at 5% by mass, 7.5% by mass, 10% by mass, or 20% by mass were prepared. MMMs comprising the unmodified phenyl-POSS particles at 5% by mass, 10% by mass or 20% by mass and PIM-1 were also prepared.

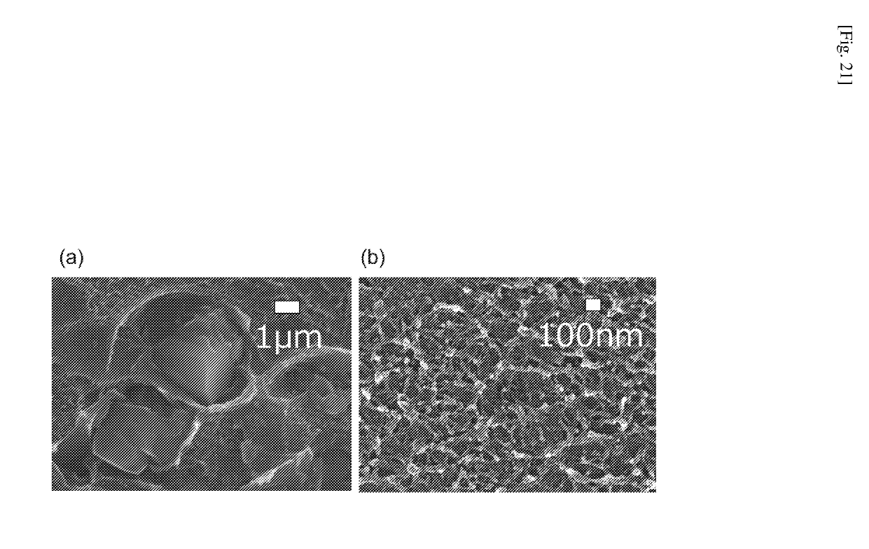

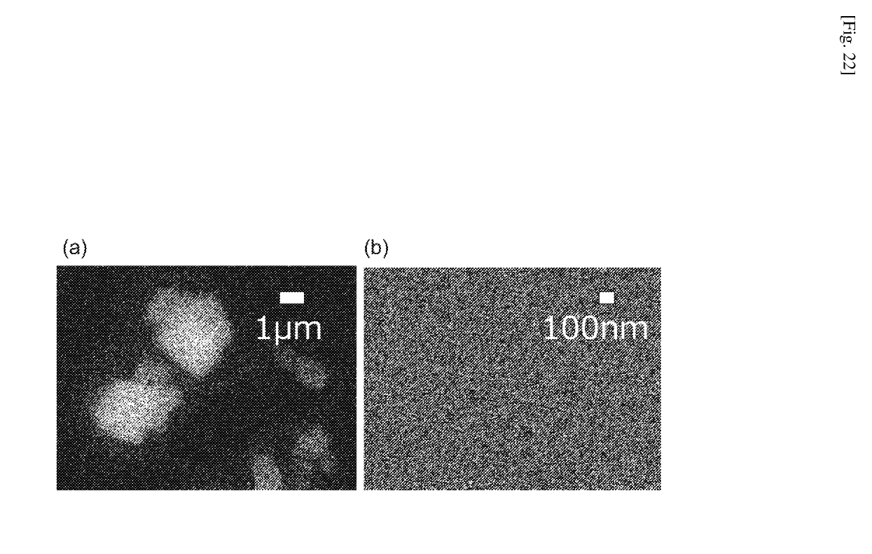

The thicknesses of the obtained MMMs were within the range of 80-100 micrometers, as measured by a micrometer (Mitutoyo, Model 5406, Japan). FIG. 21 shows SEM images of the MMMs comprising the phenyl-POSS particles (a) or the NH₂-POSS particles (b) at 5% by mass. FIG. 22 shows elemental mappings of the MMMs comprising the phenyl-POSS particles (a) or the NH₂-POSS particles (b) at 5% by mass obtained with the SEM equipped with an elemental analysis function. It was confirmed that the introduction of the polar functional groups results in high dispersion of the POSS particles in nanoscale. The unmodified phenyl-POSS particles gave a membrane with deficiencies due to aggregation of the particles.

The gas permeability coefficient of the MMMs of the POSS particles were evaluated in the same manner as described above. Table 3 shows CO₂ permeability coefficient and CO₂/CH₄ selectivity of the MMMs. The MMMs of achieved higher CO₂/CH₄ selectivity than the MMMs of the phenyl-POSS particles, while having sufficiently high CO₂ permeability coefficient.

TABLE 3

| | CO₂ permeability | CO₂/CH₄ |
|---|---|---|
| | coefficient (Barrer) | selectivity |
| NH₂-POSS (2.5 wt. %) | 3734 | 13.8 |
| NH₂-POSS (5 wt. %) | 3266 | 16.2 |
| NH₂-POSS (7.5 wt. %) | 1166 | 22.1 |
| NH₂-POSS (10 wt. %) | 578.2 | 26.8 |
| NH₂-POSS (20 wt. %) | 76.5 | 41.7 |
| phenyl-POSS (5 wt. %) | 5380 | 11 |
| phenyl-POSS (10 wt. %) | 6588 | 10.5 |
| phenyl-POSS (20 wt. %) | 7420 | 10.4 |

Fabrication of Membranes 2

The phenyl-POSS particles, the NO₂-POSS particles and the NH₂-POSS particles were dispersed and sonicated in THF and introduced to a PIM-1 solution (8 wt. %) in various contents of 2.5, 5, 7.5, 10, and 20 wt. %. The resulting PIM-1/POSS solutions were used to fabricate MMMs in the same manner with “Fabrication of membrane 1”. The thickness of the final MMMs was between 70 to 80 μm, depending on the contents of POSSs as measured by a micrometer (Mitutoyo 5406, Japan).

The gas permeability coefficient of the resulting MMMs modified with the POSS particles were evaluated in the same manner as described above. Tables 4 and 5 show permeability coefficients and selectivity values of the MMMs.

TABLE 4

| | permeability coefficient (Barrer) | | | | |
|---|---|---|---|---|---|
| | H₂ | CO₂ | O₂ | N₂ | CH₄ |
| PIM-1 | 2504 ± 128 | 4087 ± 208 | 965.5 ± 69.5 | 255.9 ± 22.2 | 335.0 ± 21.0 |
| PIM-1/phenyl-POSS | 3108 ± 165 | 5240 ± 262 | 1184 ± 79 | 376.5 ± 29.0 | 489.5 ± 31.8 |
| (5 wt. %) | | | | | |
| PIM-1/phenyl-POSS | 3811 ± 172 | 6589 ± 316 | 1488 ± 104 | 486.5 ± 35.0 | 615.3 ± 38.1 |
| (10 wt. %) | | | | | |
| PIM-1/phenyl-POSS | 4103 ± 181 | 7420 ± 312 | 1707 ± 118 | 576.1 ± 37.4 | 714.8 ± 42.9 |
| (20 wt. %) | | | | | |
| PIM-1/NO₂-POSS | 2497 ± 130 | 3884 ± 198 | 915.8 ± 64.1 | 223.2 ± 13.8 | 285.1 ± 20.0 |
| (5 wt. %) | | | | | |
| PIM-1/NO₂-POSS | 1895 ± 106 | 3002 ± 159 | 676.7 ± 47.4 | 164.7 ± 12.8 | 194.7 ± 14.7 |
| (10 wt. %) | | | | | |
| PIM-1/NO₂-POSS | 1582 ± 87 | 2416 ± 126 | 482.1 ± 34.2 | 115.1 ± 8.9 | 147 ± 11.0 |
| (20 wt. %) | | | | | |
| PIM-1/NH₂-POSS | 2479 ± 129 | 3811 ± 160 | 920.4 ± 65.3 | 230.1 ± 16.6 | 303.3 ± 22.8 |
| (2.5 wt. %) | | | | | |
| PIM-1/NH₂-POSS | 2476 ± 111 | 3266 ± 150 | 789.5 ± 53.7 | 157.1 ± 11.8 | 201.2 ± 15.1 |
| (5 wt. %) | | | | | |
| PIM-1/NH₂-POSS | 2080 ± 96 | 1203 ± 60.2 | 269.9 ± 19.4 | 47.7 ± 3.5 | 54.4 ± 4.2 |
| (7.5 wt. %) | | | | | |
| PIM-1/NH₂-POSS | 1025 ± 64 | 542.1 ± 28.2 | 123.9 ± 8.7 | 18.3 ± 1.4 | 20.2 ± 1.5 |
| (10 wt. %) | | | | | |
| PIM-1/NH₂-POSS | 329.5 ± 20.1 | 81.7 ± 5.7 | 17.1 ± 1.3 | 1.61 ± 0.14 | 1.96 ± 0.18 |
| (20 wt. %) | | | | | |

TABLE 5

| | selectivity | | | | |
|---|---|---|---|---|---|
| | O₂/N₂ | CO₂/N₂ | CO₂/CH₄ | H₂/N₂ | H₂/CH₄ |
| PIM-1 | 3.77 ± 0.41 | 16.0 ± 1.5 | 12.2 ± 1.1 | 9.78 ± 0.94 | 7.47 ± |
| | | | | | 0.68 |
| PIM-1/ | 3.14 ± 0.32 | 13.9 ± 1.3 | 10.7 ± 0.9 | 8.25 ± 0.77 | 6.35 ± |
| phenyl- | | | | | 0.53 |
| POSS | | | | | |
| (5 wt. %) | | | | | |
| PIM-1/ | 3.06 ± 0.31 | 13.5 ± 1.2 | 10.7 ± 0.8 | 7.83 ± 0.67 | 6.19 ± |
| phenyl- | | | | | 0.47 |
| POSS | | | | | |
| (10 wt. %) | | | | | |
| PIM-1/ | 2.96 ± 0.28 | 12.9 ± 1.0 | 10.4 ± 0.8 | 7.12 ± 0.56 | 5.74 ± |
| phenyl- | | | | | 0.43 |
| POSS | | | | | |
| (20 wt. %) | | | | | |
| PIM-1/ | 4.10 ± 0.38 | 17.4 ± 1.4 | 13.6 ± 1.2 | 11.2 ± 0.9 | 8.76 ± |
| NO₂-POSS | | | | | 0.76 |
| (5 wt. %) | | | | | |
| PIM-1/ | 4.11 ± 0.43 | 18.2 ± 1.7 | 15.4 ± 1.4 | 11.5 ± 1.1 | 9.74 ± |
| NO₂-POSS | | | | | 0.91 |
| (10 wt. %) | | | | | |
| PIM-1/ | 4.19 ± 0.44 | 21.0 ± 2.0 | 16.4 ± 1.5 | 13.8 ± 1.3 | 10.7 ± 1.0 |
| NO₂-POSS | | | | | |
| (20 wt. %) | | | | | |
| NH₂-POSS | 4.00 ± 0.40 | 16.6 ± 1.4 | 12.6 ± 1.1 | 10.8 ± 0.96 | 8.17 ± |
| (2.5 wt. %) | | | | | 0.75 |
| NH₂-POSS | 5.02 ± 0.51 | 20.8 ± 1.8 | 16.2 ± 1.4 | 15.8 ± 1.38 | 12.3 ± 1.1 |
| (5 wt. %) | | | | | |
| NH₂-POSS | 5.66 ± 0.58 | 25.2 ± 2.2 | 22.1 ± 2.0 | 43.6 ± 3.8 | 38.3 ± 3.4 |
| (7.5 wt. %) | | | | | |
| NH₂-POSS | 6.77 ± 0.71 | 29.6 ± 2.8 | 26.8 ± 2.5 | 56.0 ± 5.6 | 50.7 ± 4.9 |
| (10 wt. %) | | | | | |
| NH₂-POSS | 10.7 ± 1.3 | 50.8 ± 5.7 | 41.8 ± 4.8 | 204.7 ± | 168.1 ± |
| (20 wt. %) | | | | 21.9 | 18.3 |

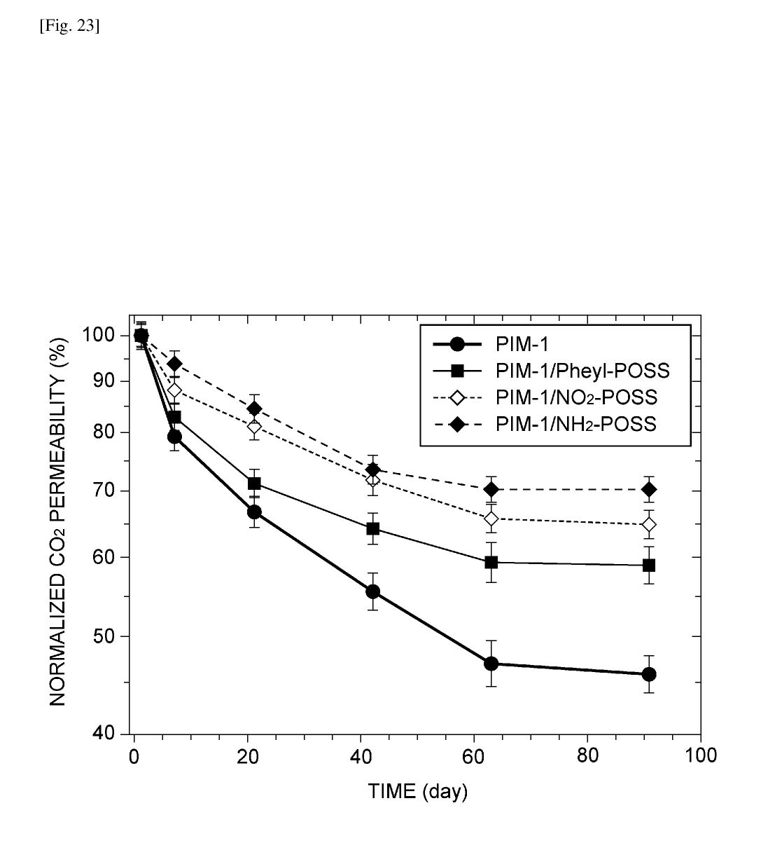

The long-term durability of the MMMs was also evaluated. The prepared MMMs were left in a vacuum environment at 25 degrees C. The CO₂ permeability coefficient of the MMMs including the NO₂-POSS or NH₂-POSS particles at 5 wt. % was measured from right after preparing the membrane to 90 days after the preparing. FIG. 23 is a graph showing a relationship between the CO₂ permeability coefficient and duration time. The CO₂ permeability coefficient is expressed as relative values with respect to initial values. It was confirmed that the introduction of the polar functional groups results in durability improvement of the MMMs.

1-14. (canceled)

15. A composite membrane comprising a mixed matrix membrane comprising:
a polymer matrix comprising a polymer having a polar functional group, the H₂ permeability coefficient of the polymer matrix being 20 Barrer or more at 4 bar and 298 K; and
a filler having a polar functional group, having an average diameter of 100 nm or less, and dispersed in the polymer matrix.

16. The composite membrane according to claim 15, wherein the polar functional group of the filler is capable of forming a hydrogen bond with the polar functional group of the polymer.

17. The composite membrane according to claim 15, wherein the porous filler comprises at least one selected from the group consisting of a metal organic framework particle, a zeolite particle and a silica gel particle.

18. The composite membrane according to claim 15, wherein the filler include a polyhedral oligomeric silsesquioxane particle.

19. The composite membrane according to claim 15, wherein the filler comprises at least one selected from the group consisting of an organic or inorganic nanotube, an organic or inorganic nanosheet, and a nanodiamond.

20. The composite membrane according to claim 15, wherein the content of the filler is 50% by mass or less with respect to the total mass of the mixed matrix membrane.

21. The composite membrane according to claim 15, wherein the content of the filler is 20% by mass or less with respect to the total mass of the mixed matrix membrane.

22. The composite membrane according to claim 15, wherein the H₂ permeability coefficient of the polymer matrix is 200 Barrer or more at 4 bar and 298 K.

23. The composite membrane according to claim 15, wherein
one of the polar functional group of the polymer or the polar functional group of the filler includes at least one kind selected from the group consisting of an amide group, an carboxyl group, a hydroxyl group and an amino group, and
the other includes at least one kind selected from the group consisting of an amide group, a nitrile group, an ether group, a carboxylic acid ester group, ketone group, a nitro group and a halide group.

24. The composite membrane according to claim 15, wherein the thickness of the mixed matrix membrane is 3.0 micrometers or less.

25. The composite membrane according to claim 15, wherein the composite membrane further comprises a porous substrate, and the mixed matrix membrane is stacked on the porous substrate.

26. A method of separating a predetermined gas from a mixed gas, the method comprising:
causing the predetermined gas in the mixed gas to pass selectively through the composite membrane according to claim 15, the predetermined gas being at least one kind of gas selected from the group consisting of: hydrocarbon; and other gases containing at least one of a hydrogen atom, a sulphur atom, an oxygen atom or a nitrogen atom.

27. The method according to claim 26, wherein the predetermined gas is at least one kind of gas selected from the group consisting of H₂, H₂S, CO, CO₂, alkane, alkene, N₂ and O₂.
